(19) United States
(12) Patent Application Publication
(10) Pub. No.: US 2007/0113055 A1
(43) Pub. Date: May 17, 2007

(54) Apparatus and method for improving single thread performance through speculative processing

(76) Inventors: Jason N. Dale, Austin, TX (US); H. Peter Hofstee, Austin, TX (US); Albert James Van Norstrand JR., Round Rock, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/274,838

(22) Filed: Nov. 15, 2005

(51) Int. Cl. G06F 9/44

(52) U.S. Cl. 712/228

(57) ABSTRACT

An apparatus, method and computer program product are provided for using multiple thread contexts to improve processing performance of a single thread. When an exceptional instruction is encountered, the exceptional instruction and any predicted instructions are reloaded into a buffer of a first thread context. A state of the register file at the time of encountering the exceptional instruction is maintained in a register file of the first thread context. The instructions in the pipeline are executed speculatively using a second register file in a second thread context. During speculative execution, cache misses may cause loading of data to the cache may be performed. Results of the speculative execution are written to the second register file. When a stopping condition is met, contents of the first register file are copied to the second register file and the reloaded instructions are released to the execution pipeline.

### BACKGROUND

1. Technical Field

The present application relates generally to an improved data processing system and method. More specifically, the present application is directed to an apparatus and method to improve single thread performance by using speculative processing of instructions associated with the thread following the detection of an exceptional instruction.

2. Description of Related Art

One of the key characteristics of high-frequency processor designs is the ability to tolerate and/or hide latency, including system memory latency. By tolerating or hiding latency, high-frequency processors can operate with higher performance. In addition to system memory latencies, latency can also occur from pipeline flushes. Pipeline flushes occur when the processor flushes out a group of instructions within its pipeline and reinserts those instructions at the beginning of the pipeline. However, high-frequency processors contain long pipelines, which can exacerbate the latency inherent with pipeline flushes. On the other hand, memory latency can occur when the processor experiences a cache miss, whereby information must then be retrieved outside the processor, often from a much slower system memory.

Typically, the processor either tolerates latency by executing instructions out-of-order in its execution pipeline, as seen in an out-of-order processor, or hides latency by performing some other useful task while waiting for long latency operations, as seen in multi-threaded processors. A thread is commonly known by those skilled in the art, and is a portion of a program or a group of ordered instructions that can execute independently or concurrently with other threads.

Out-of-order processing occurs when a processor executes instructions in an order that is different from the thread's specified program order. This type of processing requires instruction reordering, register re-naming, and/or memory access reordering, which must be resolved through complex hardware mechanisms. Thus, while out-of-order processing allows a single threaded processor to tolerate latencies, out-of-order processing requires complex schemes and additional resources in order to be realized.

### SUMMARY

In view of the above, it would be beneficial to have an in-order multi-threaded processor, which may operate in a similar manner as a single-threaded processor while gaining many of the advantages of an out-of-order processor without the associated complexity. The illustrative embodiment provides such an in-order multi-threaded processor mechanism. Specifically, the illustrative embodiment provides an apparatus and method for using multiple thread contexts to improve single thread performance.

With the mechanisms of the illustrative embodiment, when an instruction running on a first thread context is encountered whose processing cannot be completed, i.e. an exceptional instruction, such as a cache load miss, the exceptional instruction and predicted instructions following the exceptional instruction are reloaded into a buffer of a second thread context. The state of the register file at the time of encountering the exceptional instruction is maintained in a second register file associated with the second thread context. This state is referred to as the “architected” state.

Meanwhile, the instructions from the first thread context in the pipeline are permitted to continue processing using a first register file associated with a first thread context. This continued processing permits execution to continue down a speculative path with results of the speculative execution of instructions being used to update only the first register file. The updates to the first register file when speculatively executing instructions in the pipeline is referred to as the “speculative” state. In the context of the present description, the term “speculative” execution is meant to refer to the execution of instructions following the encountering of an exceptional instruction such that updates to the state of the “architected” register file based on the execution of these instructions are not maintained during normal, i.e. non-speculative, execution of instructions in the pipeline, meaning that the results from the speculative execution are discarded after the speculative execution has discontinued. While this speculative execution is being performed, other cache load misses may be encountered. As a result, the data/instructions associated with these cache load misses will be reloaded into the cache in accordance with standard cache load miss handling.

When it is determined that the processing down the speculative path is to be discontinued, e.g., when the original exceptional instruction is able to complete, after executing some number of branches or other instructions, or when otherwise determined by a control unit, the updates to the first, speculative, register file are discarded and copied over with the contents of the second, or architectural, register file. The reloaded instructions in the second thread context are released to the execution units in the pipeline and execution of the instructions is then permitted to continue in a normal fashion until a next exceptional instruction is encountered, at which time the process may be repeated.

Since the speculative processing of the illustrative embodiment is allowed to be performed rather than flushing the instructions in the pipeline and waiting for the exceptional instruction to complete, data that will be required by load instructions in the reloaded instructions from the first thread context will have their data present in the cache. As a result, fewer cache load misses will most likely be encountered during the execution of the reloaded instructions. Thus, the illustrative embodiment permits speculative processing of instructions in one thread context while the instructions are being reloaded in a different thread context. This speculative processing permits pre-fetching of data into the cache so as to avoid cache load misses by the re-loaded instructions when they are permitted to execute in the pipeline. By utilizing the other thread context to reload instructions and hold them, the penalty for pipeline flushing after the speculative execution is also minimized. As a result, performance of the processing of a single thread is improved by reducing the number of cache load misses that must be handled during in-order processing of instructions.

In one illustrative embodiment, a method, in a data processing system having a pipeline and a cache, for processing a thread is provided. The method may comprise detecting a cache miss instruction in the pipeline that results in a cache miss when executed and performing a first thread context switch operation for switching from a first thread context to a second thread context in response to detecting the cache miss instruction. The method may further comprise continuing execution of the thread in the pipeline in association with the second thread context without modifying an architected state of a register file at the time that the cache miss instruction is detected and without flushing the pipeline after detection of the cache miss instruction, such that instructions associated with the thread that are processed after the detection of the cache miss instruction are used to pre-fetch data into the cache.

The architected state may be stored in a first register file in association with the first thread context. The method may further comprise updating, in response to continuing execution of the thread, a state of the execution of the thread in a second register file in associated with the second thread context. The method may further comprise stopping the continuing execution of the thread in the pipeline in response to a criteria being met and restoring the architected state to the second register file in response to stopping the continuing execution of the thread in the pipeline. The criteria may comprise completion of loading of data required by the exceptional instruction into the cache.

The method may also comprise re-fetching the cache miss instruction, storing the re-fetched cache miss instruction in an instruction buffer associated with the first thread context. The re-fetched cache miss instruction may be released to the pipeline after restoring the architected state to the second register file.

The execution of the thread may be continued in the pipeline following the detection of the cache miss instruction by determining if processing of an instruction of the thread results in a cache miss. One of an instruction or a data value may be reloaded into the cache in response to determining that the instruction results in a cache miss.

The method may further comprise setting a bit identifying the pipeline to be executing in a speculative mode following detection of the cache miss instruction. The method may mark an entry in a register file accessed by the cache miss instruction as invalid in response to detection of the cache miss instruction. In such a case, continuing execution of the thread in the pipeline may comprise marking entries in a register file accessed by instructions that are dependent upon the cache miss instruction as invalid.

With the method, performing the first thread context switch operation may comprise storing the architected state in a register file associated with the first thread context in response to detecting the cache miss instruction. In addition, modifications to the architected state in the first thread context may be disabled.

The method may further comprise detecting another cache miss instruction in the pipeline following restoring the architected state and performing a second thread context switch operation for switching from the second thread context to the first thread context. The second thread context switch operation may comprise storing a second architected state of the thread in the second register file, wherein the second architected state is a state of execution of the thread at a time of detection of the second cache miss instruction. The second thread context switch operation may further comprise disabling modification of the second architected state in the second register file.

In other illustrative embodiments, an apparatus, data processing system, and computer program product in a computer readable medium are provided for performing the operations of the method outlined above. The apparatus and/or data processing system may comprise at least one processor and at least one memory coupled to the processor. The at least one processor may comprise an execution pipeline, a first general purpose register, coupled to the execution pipeline, that stores a first register file, a second general purpose register, coupled to the execution pipeline, that stores a second register file, a cache coupled to the execution pipeline, and a controller coupled to the execution pipeline, the first general purpose register, and the second general purpose register.

With such an apparatus or system, the execution pipeline may detect a cache miss instruction in the pipeline that results in a cache miss when executed and store an architected state in response to detecting the cache miss instruction, wherein the architected state is a state of execution of the thread at the time that the cache miss instruction is detected. The execution pipeline may further disable modifications to the architected state and continue execution of the thread in the pipeline without modifying the architected state and without flushing the pipeline after detection of the cache miss instruction, such that instructions associated with the thread that are processed after the detection of the cache miss instruction are used to pre-fetch data into the cache.

These and other features and advantages of the illustrative embodiment will be described in, or will become apparent to those of ordinary skill in the art in view of, the following detailed description of the exemplary embodiments of the illustrative embodiment.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a data processing system in which aspects of the illustrative embodiment may be implemented;

FIG. 2 is an exemplary block diagram of a processor in accordance with an exemplary embodiment illustrative of the present invention;

FIG. 3 is an exemplary block diagram of a processor pipeline containing multiple thread contexts in accordance with an exemplary embodiment illustrative of the present invention;

FIGS. 4A-4C are exemplary diagrams illustrating an operation of the primary operational elements of a processor pipeline in accordance with an exemplary embodiment illustrative of the present invention; and

FIG. 5 is a flowchart outlining an exemplary operation for processing thread having an exceptional instruction in accordance with one exemplary embodiment illustrative of the present invention.

### DETAILED DESCRIPTION OF THE PREFERRED EMBODIMENTS

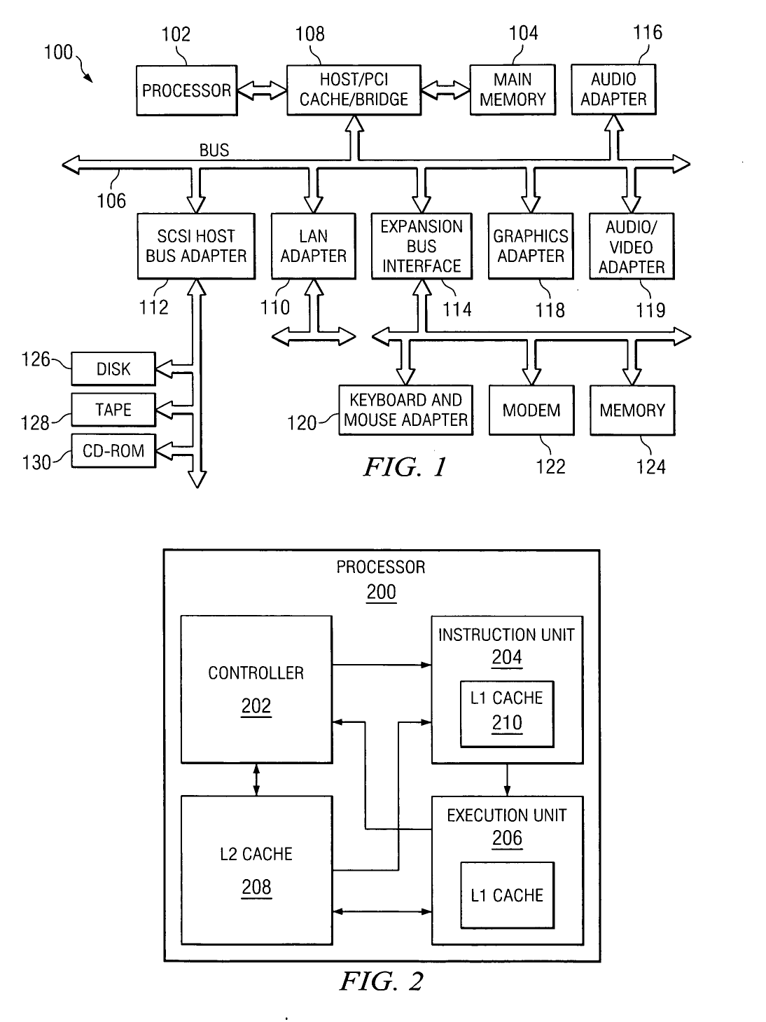

The illustrative embodiment provides an apparatus, system and method in which the performance of the processing of a single thread is improved by using multiple thread contexts. The mechanisms of the illustrative embodiment may be implemented, for example, in a processor of a data processing system. The processor may have any one of a number of different architectures without departing from the spirit and scope of the present invention. Moreover, a data processing system in which aspects of the illustrative embodiment may be implemented may comprise one or more processors incorporating the mechanism of the illustrative embodiment. The following FIGS. 1 and 2 illustrate an exemplary data processing system and processor in which exemplary aspects of the illustrative embodiment may be implemented.

While the following figures will set forth exemplary embodiments illustrative of the present invention, it should be appreciated that the present invention is not limited to such exemplary embodiments. Many modifications, as will be readily apparent to those of ordinary skill in the art in view of the present description, may be made to the architectures and arrangements of elements set forth in the following figures without departing from the spirit and scope of the present invention.

With reference now to FIG. 1, a block diagram of a data processing system is shown in which the illustrative embodiment may be implemented. Data processing system 100 is an example of a computer in which code or instructions implementing the processes of the illustrative embodiment may be located. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in connectors. In the depicted example, local area network (LAN) adapter 110, small computer system interface (SCSI) host bus adapter 112, and expansion bus interface 114 are connected to PCI local bus 106 by direct component connection.

In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. SCSI host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system such as Windows XP, which is available from Microsoft Corporation. An object oriented programming system such as Java may run in conjunction with the operating system and provides calls to the operating system from Java programs or applications executing on data processing system 100. “Java” is a trademark of Sun Microsystems, Inc. Instructions for the operating system, the object-oriented programming system, and applications or programs are located on storage devices, such as hard disk drive 126, and may be loaded into main memory 104 for execution by processor 102.

Those of ordinary skill in the art will appreciate that the hardware in FIG. 1 may vary depending on the implementation. Other internal hardware or peripheral devices, such as flash read-only memory (ROM), equivalent nonvolatile memory, or optical disk drives and the like, may be used in addition to or in place of the hardware depicted in FIG. 1. Also, the processes of the illustrative embodiment may be applied to a multiprocessor data processing system.

For example, data processing system 100, if optionally configured as a network computer, may not include SCSI host bus adapter 112, hard disk drive 126, tape drive 128, and CD-ROM 130. In that case, the computer, to be properly called a client computer, includes some type of network communication interface, such as LAN adapter 110, modem 122, or the like. As another example, data processing system 100 may be a stand-alone system configured to be bootable without relying on some type of network communication interface, whether or not data processing system 100 comprises some type of network communication interface. As a further example, data processing system 100 may be a personal digital assistant (PDA), which is configured with ROM and/or flash ROM to provide non-volatile memory for storing operating system files and/or user-generated data.

The depicted example in FIG. 1 and above-described examples are not meant to imply architectural limitations. For example, data processing system 100 also may be a notebook computer or hand held computer in addition to taking the form of a PDA. Data processing system 100 also may be a kiosk or a Web appliance.

As mentioned above, the mechanisms of the illustrative embodiment may be implemented in any processor of a data processing system. For example, the mechanisms of the illustrative embodiment may be implemented in processor 102 of data processing system 100. Moreover, the illustrative embodiment is not limited to a single processor architecture as illustrated in FIG. 1. To the contrary, the illustrative embodiment may be implemented in any architecture having one or more processors.

In one exemplary embodiment, the illustrative embodiment is implemented in the Cell Broadband Engine architecture (CBEA) available from International Business Machines, Inc. of Armonk, N.Y. The CBEA architecture may be provided as a system-on-a-chip. The CBEA is a heterogeneous processing environment having a PowerPC™ processing unit (PPU) that acts as a control processor and a plurality of co-processing units referred to as synergistic processing units (SPUs) that operate under the control of the PPU. Each of the SPUs may receive different instructions from each of the other SPUs in the system. Moreover, the instruction set for the SPUs may be different from that of the PPU, e.g., the PPU may execute Reduced Instruction Set Computer (RISC) based instructions while the SPU may execute vectorized instructions. The mechanisms of the illustrative embodiment may be implemented in any one or all of the SPUs and PPU in the CBE architecture without departing from the spirit and scope of the present invention.

The data processing system may be provided as part of any one of a number of different types of computerized end products. For example, the end products in which the data processing system may be provided may include game machines, game consoles, hand-held computing devices, personal digital assistants, communication devices, such as wireless telephones and the like, laptop computing devices, desktop computing devices, server computing devices, or any other computing device.

The mechanisms of the illustrative embodiment make use of multiple thread contexts to aid in improving the processing of a single thread. Essentially, these multiple thread contexts permit speculative processing of instructions following an instruction whose processing cannot be completed such that subsequent cache load misses may be identified and the data/instructions for these subsequent cache load misses may be pre-fetched into the cache before re-issuing instructions to the pipeline.

With the mechanisms of the illustrative embodiment, when an instruction is encountered whose processing cannot be completed, i.e. an exceptional instruction, such as a cache load miss, the exceptional instruction and other predicted instructions following the exceptional instruction are thereafter reloaded into a buffer in a second thread context. A state of the register file at the time of encountering the exceptional instruction is maintained in a general purpose register associated with a second thread context.

Meanwhile, the instructions in the pipeline from the first context are permitted to continue processing using the first register file, associated with the first thread context. This continued processing permits execution to continue down a speculative path with updates to the register file being made to a partially valid version of the register file. While this speculative execution is being performed, other cache load misses may be encountered. As a result, the data associated with these cache load misses will be reloaded into the cache in accordance with standard cache load miss handling.

When it is determined that the processing down the speculative path by the first thread context is to be discontinued, e.g., when the original exceptional instruction is able to complete, after executing some number of branches or other instructions, or when otherwise determined by a control unit, the contents of the partially valid version of the register file are discarded and the reloaded instructions in the second thread context are released to the execution units in the pipeline and the contents of the general purpose register of the second thread context are copied over to the general purpose register of the first thread context. Execution of the instructions is then permitted to continue in a normal fashion until a next exceptional instruction is encountered at which time the process may be repeated.

Since the speculative processing of the illustrative embodiment was permitted to be performed, data that is required by load instructions in the reloaded instructions from the second thread context will have their data present in the cache. As a result, fewer cache load misses will most likely be encountered during the execution of the reloaded instructions. Thus, the illustrative embodiment permits speculative processing of instructions in one thread context while the instructions are being reloaded in a different thread context. This speculative processing permits pre-fetching of data into the cache so as to avoid cache load misses by the re-loaded instructions when they are permitted to execute in the pipeline. By utilizing the other thread context to reload instructions and hold them, the penalty for pipeline flushing after the speculative execution is also minimized. As a result, performance of the processing of a single thread is improved by reducing the number of cache load misses that must be handled during in-order processing of instructions.

FIG. 2 is an exemplary block diagram of a processor 200 in accordance with an exemplary embodiment illustrative of the present invention. Processor 200 includes controller 202, which controls the flow of instructions and data into and out of processor 200. Controller 202 sends control signals to instruction unit 204, which includes an L1 cache. Instruction unit 204 issues instructions to execution unit 206, which also includes an L1 cache. Execution unit 206 executes the instructions and holds or forwards any resulting data results to, for example, L2 cache 208. In turn, execution unit 206 retrieves data from L2 cache 208 as appropriate. Instruction unit 204 also retrieves instructions from L2 cache 208 when necessary. Controller 202 sends control signals to control storage or retrieval of data from L2 cache 208. Processor 200 may contain additional components not shown, and is merely provided as a basic representation of a processor and does not limit the scope of the present invention.

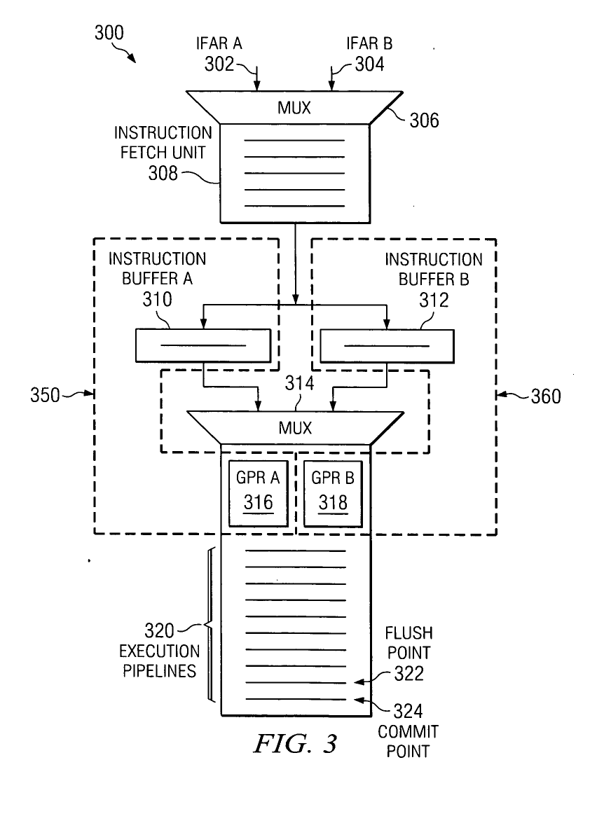

FIG. 3 is an exemplary block diagram of a processor pipeline 300 containing multiple thread contexts in accordance with an exemplary embodiment illustrative of the present invention. Processor pipeline 300 may reside within execution unit 206, instruction unit 204, and other locations (not shown) within processor 200 in FIG. 2. Importantly, processor pipeline 300 represents one exemplary embodiment illustrative of the present invention and is used to explain the novel concepts of the invention, but is not intended to limit the scope of the invention, which is defined by the attached claims. Processor pipeline 300 may process multiple threads or, alternatively, use multiple thread contexts to enhance the performance of a single thread.

Input lines 302 and 304 represent instruction addresses, supplied by controller 202, that are provided to processor pipeline 300. Input line 302 receives an instruction address from instruction fetch address register A (IFAR A), and input line 304 receives an instruction address from instruction fetch address register B (IFAR B). In the conventional multi-threading mode, multiplexer (MUX) 306 repeatedly selects one instruction address from either thread A or thread B and pushes it into instruction fetch unit 308. For each instruction address, instruction fetch unit 308 fetches the appropriate instruction, or instructions, from for example, L1 cache 210 in instruction unit 204 in FIG. 2. Subsequently, instruction buffer A 310 holds the fetched instructions from thread A, and instruction buffer B 312 holds the fetched instructions from thread B.

Instruction buffers 310 and 312 supply the fetched instructions to multiplexer (MUX) 314, which in turn provides the fetched instructions to the execution pipeline 320 in program order for execution. The instructions read the general purpose registers (“GPR”) 316 and 318 as necessary. Accordingly, GPR 316 holds data values for thread A, and GPR 318 holds data values for thread B. GPRs 316 and 318 are the register files for the execution pipeline 320.

Processor pipeline 300 detects any incorrect or exceptional instructions, i.e. instructions whose processing cannot be completed, within the execution pipeline 320. The “exceptional” condition, in one exemplary embodiment illustrative of the present invention, is a load instruction that results in a cache miss and thus, gives rise to a long latency operation. A cache miss is a failure to find a required instruction or portion of data in the cache. A cache miss is only one example of an exceptional condition that may be used with the mechanisms of the illustrative embodiment. The illustrative embodiment is not limited to use of cache misses as an exceptional condition upon which the mechanisms of the illustrative embodiment operate. Other examples of exceptional conditions include pipeline flushes, non-pipelined instructions, store misses, address translation misses, and the like.

In one exemplary embodiment illustrative of the present invention, detection of an exceptional condition or exceptional instruction occurs near the end of the execution pipeline 320, for example, at flush point 332. When processor pipeline 300 detects an instruction at flush point 322 that cannot complete (i.e. the “exceptional” instruction), in conventional multi-threading mode, the processor pipeline 300 flushes that instruction and all subsequent instructions for that thread from the processor pipeline 300. Following the flush, the processor pipeline 300 must then re-fetch and re-execute all of the instructions that were flushed, thereby exposing the latency inherent in the processor pipeline 300. When the previously “exceptional” instruction is able to complete, the execution pipeline 320 commits the instruction at commit point 324. This means that processor pipeline 300 has executed the instruction and will “writeback” the data results to the register files in GPRs 316 and 318 and/or memory (e.g., cache 208, 210, 212, system or main memory 104.

Thus, because exceptional instructions cause flushes of the execution pipeline, refetching of the flushed instructions, and re-execution of the instructions in the execution pipeline, a large amount of latency is associated with the processing of threads encountering exceptional instructions. This latency is made larger by the fact that instructions in the pipeline that may have not been detected as having been exceptional, but were flushed due to another instruction having been detected as being an exceptional instruction, may cause a subsequent flushing of the pipeline when their exceptional state is later detected. This may occur sequentially many times for a single thread, thereby causing a large latency in the processing of the thread. The illustrative embodiment seeks to improve upon the processing of a thread so that such large latencies are avoided.

In accordance with an exemplary embodiment illustrative of the present invention, processor pipeline 300 may continue executing instructions immediately after detecting an exceptional instruction, which conventionally would have caused a flush to occur, or would otherwise have prevented forward progress of execution in an in-order pipeline (or would have at the least exposed or created additional latency), such as a cache miss followed by a dependent instruction. To do so, an embodiment of the current invention uses one thread to speculatively execute subsequent instructions and another thread to prepare to resume regular execution following handling of the exceptional instruction.

In this single-threaded mode, as processor pipeline 300 executes one thread of instructions, the same results from completed instructions are simultaneously written to both GPR A 316 and GPR B 318. However, once the processor detects an exceptional instruction (such as a cache miss), processor pipeline 300 disables writebacks to only one of register files GPR 316 or 318, herein referred to as the “architectural” register file (for example, GPR 318). The other register file (e.g., GPR 316) is then used as a “speculative” register file, and execution proceeds past the exceptional instruction, using the speculative register file to hold results.

At this point, the architectural thread fetches the exceptional instruction, plus any subsequent predicted instructions and holds them (in Instruction Buffer B 312, for example), while the speculative thread continues to execute instructions past the exceptional instruction. The pipeline 300 stops executing along the speculative path after the condition which caused the exceptional instruction from completing has cleared, e.g., when the data for the exceptional instruction is loaded into the L1 cache. The pipeline 300 then copies the contents of the architectural register file into the speculative register file and releases the instructions which were queued in the instruction buffer B 312 to the execution units.

Thus, with the mechanism of the illustrative embodiment, one thread context is used to perform speculative processing of instructions that follow after an exceptional instruction. These instructions in the pipeline may include load instructions or the like, that cause cache misses and cause instructions/data to be fetched from main memory. Thus, by processing these instructions in a speculative manner, data may be pre-fetched into the L1 cache. This reduces the chances of a cache load miss during subsequent processing of instructions since the instructions/data will already be in the L1 cache.

After the exceptional instruction is detected in the pipeline in association with one thread context, the other thread context is used to re-fetch the exceptional instruction and any subsequent predicted instructions and hold them in the instruction buffers (for example, instruction buffer 312). When the speculative processing is to be stopped, the first context that was performing the speculative processing is overwritten with the architectural state while the second context to which writebacks were suspended is now permitted to operate in a non-speculative state, meaning that if a cache load miss is encountered, the second context will execute instructions speculatively in the execution pipeline and the first context will be used to store the architectural state and buffer instructions. Such switching of contexts may be performed repeatedly as often as necessary.

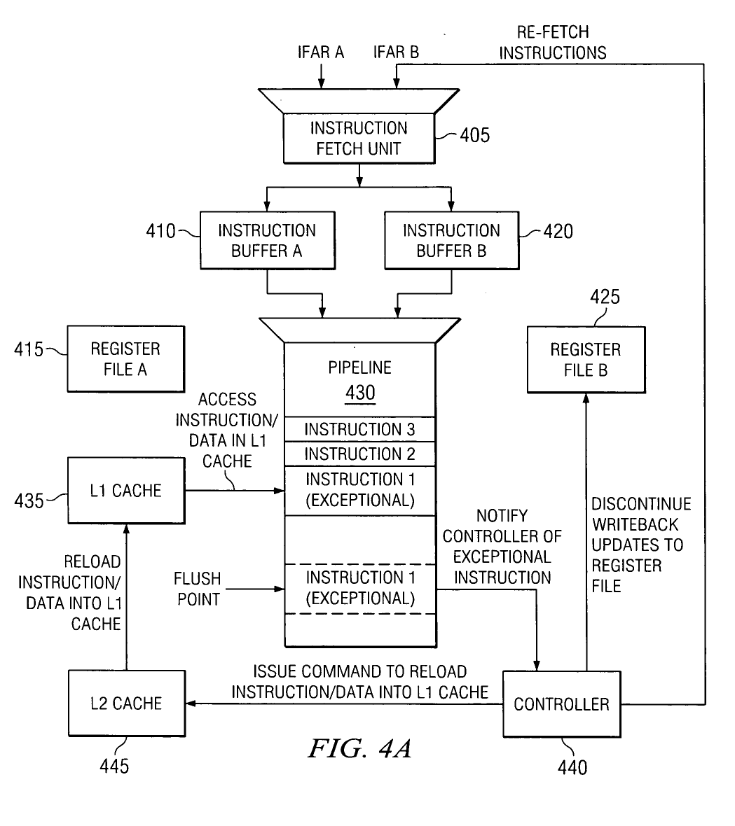

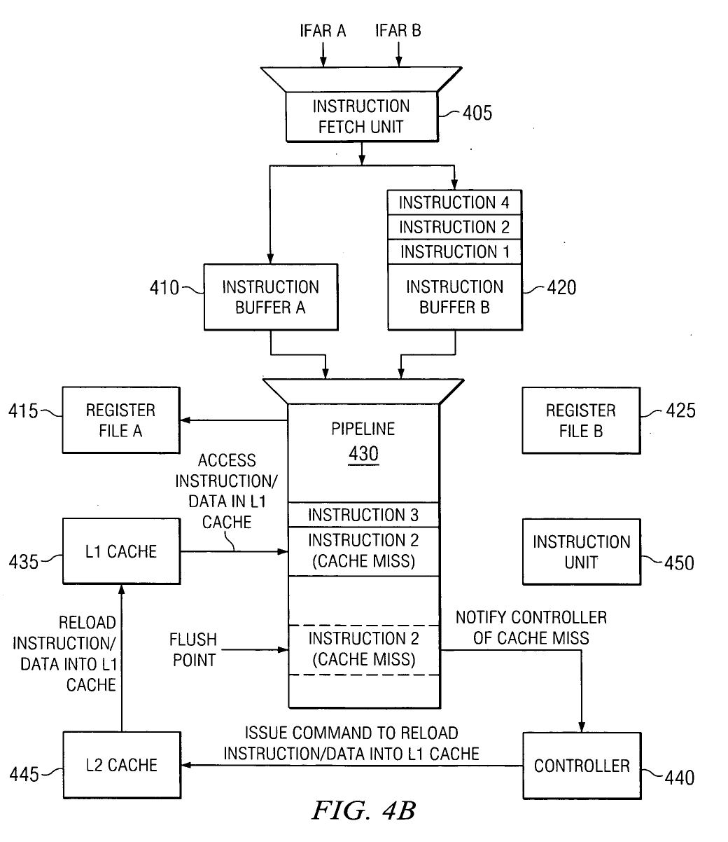

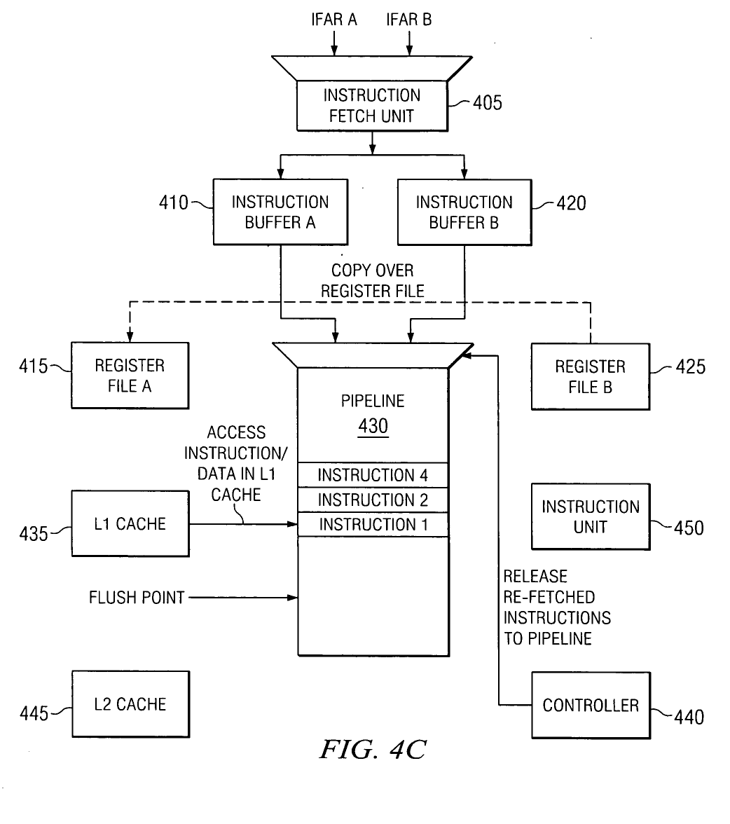

FIGS. 4A-4C illustrate an exemplary operation of an illustrative embodiment with regard to the primary operational components of a processor pipeline. In these figures, the letter designations “A” and “B” are used to identify the two different thread contexts that are used to enhance the processing of instructions in a single thread. Thus, those elements in FIGS. 4A-4C that have letter designation “A” all belong to the same thread context, i.e. the thread “A” context, and all of the elements having letter designation “B” belong to the same thread context, i.e. the thread “B” context.

As shown in FIG. 4A, a plurality of instructions, e.g., instructions 1-3, are dispatched to the pipeline 430 using instruction fetch unit 405 and instruction buffer A and B 410 and 420 in a manner as outlined above with regard to FIG. 3. In the depicted example, it will be assumed that instructions 1-3 are dispatched to the pipeline 430 from instruction buffer A 410, for example.

During normal operation of the pipeline 430, instructions are executed and their results are committed and written back to register file A 415 and register file B 425. Thus, until an exceptional instruction is encountered, register file A 415 and register file B 425 should have identical contents. Once an exceptional instruction, such as a cache load miss, is encountered, one of the register files, e.g., register file B 425, will store an architectural state of the thread's execution, i.e. a snapshot of the register file A 415 and register file B 425 at the time that the exceptional instruction is encountered. The other register file, e.g., register file A 415, will store a speculative state of the register file.

For example, during execution of instruction 1 in the pipeline 430, access to L1 cache 435 is performed to complete the processing of instruction 1. For example, instruction 1 may be a load instruction for loading a data value from the L1 cache 435. If the data value that instruction 1 needs to load is not present in the L1 cache 435, or is invalid, then a cache load miss occurs. In this case, instruction 1 is referred to as an “exceptional” instruction since the cache load miss results in an “exception” that must be handled by the controller 440. As mentioned above, the cache load miss detection, in the depicted embodiment, occurs at the flush point in the pipeline 430, although such detection may be performed at other points in the pipeline without departing from the spirit and scope of the present invention.

In response to detecting the exceptional instruction, the pipeline 430 notifies the controller 440 of the exceptional instruction. The controller 440 then discontinues updates, e.g., writebacks, to the register file B 425. In addition, the controller 440 issues a command to the L2 cache 445 to reload the required instruction/data for instruction 1 into the L1 cache 435. Such a reload may require that the L2 cache retrieve the instruction/data from main memory if the instruction/data is not present in the L2 cache 445.

In addition to issuing the command to reload the instruction/data into the L1 cache and the command to discontinue writeback updates to the register file, the controller 440 also issues instruction fetch addresses to the instruction fetch unit 405 for re-fetching the exceptional instruction and any subsequent predicted instructions. These subsequent predicted instructions may not be the same set of instructions that were originally in the pipeline when the exceptional instruction was encountered. For example, if the speculative thread has updated the branch predictor of the processor, the set of instructions that are re-fetched may be different from the set of instructions that were originally in the pipeline. The re-fetching of instructions by instruction fetch unit 405 is performed with regard to the thread “B” context such that when these instructions are re-fetched, they are stored in instruction buffer B 420 in the architectural thread context, i.e. the thread context in which the architected state is maintained in the register file. The MUX associated with pipeline 430 does not select the instructions from instruction buffer B 425 until the controller 440 discontinues speculative processing of instructions using the thread “A” context, as discussed hereafter.

With reference now to FIG. 4B, as shown, while the instructions are being refetched by the instruction fetch unit 405 and placed in instruction buffer B 420 of the architectural thread context, the instructions present in the pipeline 430 continue to be processed in the speculative thread context, i.e. the thread context in which invalid updates to the register file are permitted to continue after detection of an exceptional instruction. This speculative execution continues using the normal data bypass mechanisms provided in pipeline 430.

During this speculative execution, other instructions that result in cache load misses, or simply cache misses, may be encountered. For example, as shown in FIG. 4B, instruction 2 may access the L1 cache 435 to obtain an instruction or data value for completion of the instruction. If the instruction or data value in the L1 cache 435 is not present in the cache or is invalid, this operation will result in a cache load miss. This cache load miss will be detected at the flush point in the pipeline 430 and the pipeline 430 will notify the controller 440, e.g., by way of throwing an exception. As a result, the controller 440 will issue a command to the L2 cache 445 to reload the instruction/data values into the L1 cache 435. Thus, the speculative execution of instructions may cause data values to be pre-fetched and placed in the L1 cache 435 prior to these instructions/data values being used to update the architected state.

If this were to occur when the pipeline 430 was not undergoing speculative processing of the instructions, instruction 2 may be considered an “exceptional” instruction that would cause the mechanisms of the illustrative embodiment to initiate storing the architected state of the register file in an architectural thread context and performing speculative processing of instructions in a speculative thread context. However, since the pipeline 430 is currently operating in a speculative manner, as may be identified by the controller 440 by setting a speculative operation bit flag in the controller 440, for example, the encountering of instruction 2 does not give rise to an “exceptional” instruction being identified and initiating of the mechanisms of the illustrative embodiment. This process may continue until a stopping condition is encountered, e.g., loading of the data for the exceptional instruction into the L1 cache or other type of stopping condition.

Executing these instructions may lead to invalid register values being propagated in the register file A 415 of the speculative thread context. Because of this, the illustrative embodiment provides a valid bit with each register in the register files A and B 415 and 425. Using these valid bits, the illustrative embodiment may track which operands are valid and which are invalid. The purpose of these valid bits is to avoid sending loads to the memory system that have incorrect addresses, as these would pollute the cache and waste memory bandwidth. As there are no updates to the architected state in the architectural thread context during this time, architectural correctness is not a concern. All load and store addresses have effectively become pre-fetches at this time.

For example, when the exceptional instruction is detected, any registers in the register file A 415 which the exceptional instruction will update have their valid bit set to an “invalid” state. Thereafter, any instructions that are executed that are dependent upon a register entry which is marked as invalid will have their results marked as invalid, i.e. access a register whose value was written to by the exceptional instruction, will have the valid bits of their corresponding registers in the register file A 415 set to an “invalid” state. Thus, while updates may be made to the register file A 415 during speculative execution of instructions in the pipeline 430, effects from these invalid updates, such as load or store requests to caches or memory, will not be propagated to the cache or main memory.

After the stopping condition is encountered and thus, speculative processing of instructions in the pipeline 430 is discontinued, the pipeline may still contain some instructions that have not been processed. These instructions may be flushed from the pipeline using standard flushing mechanisms. Alternatively, a predetermined number of instructions may be fetched and issued during speculative processing of instructions and the process may wait for the processing of these instructions in the pipeline to be completed before permitting additional instructions to be fetched and issued.

Once the stopping condition is encountered, as shown in FIG. 4C, the register values in the register file B 425 (in the architectural thread context) are copied over to the registers in the register file A 415 (in the speculative thread context). Ideally, all of the register values in register file B 425 are copied over to the registers in the register file A 415 in parallel in one or a few cycles. This decreases the latency of the copy operation. By copying over the register values from register file B 425 to register file A 415, the speculative state represented in the register file A 415 is discarded and the architected state represented in the register file B 425 is restored to both register files A and B 415 and 425.

While the speculative state in register file A 415 is discarded, the use of this speculative state during speculative execution of instructions in the pipeline 430 served a valuable purpose. Specifically, by speculatively executing instructions in the pipeline 430 and updating the speculative state in the register file A 415, data values that are needed by instructions following the detected exceptional instruction are pre-fetched into the L1 cache. When the exceptional instruction and other predicted instructions are refetched and sent to the pipeline 430, these instructions will most likely not encounter a cache load miss when being executed. Thus, as a result, the execution of these refetched instructions is improved since multiple flushes of the pipeline are avoided.

After copying over of the architectural state in the register file B 425 to the register file A 415, the controller 440 issues a command to the MUX of the pipeline 430 to select instructions from instruction buffer B 420 in the architectural thread context. These instructions are then executed in the pipeline 430 in a normal fashion until a next exceptional instruction is encountered at which time the overall operation for handling exceptional instructions using two thread contexts discussed above is repeated. In addition to sending the command to the MUX of the pipeline 430, the controller 440 may reset a speculative operation flag bit in the controller 440 to indicate that the pipeline is currently not operating in a speculative manner.

Thus, instruction buffer A 410 was originally supplying instructions to the pipeline 430 for updating an architected state prior to encountering the exceptional instruction. After detecting the exceptional instruction, the instructions from instruction buffer A 410 are executed in a speculative manner and thus, instruction buffer A 410 is part of the speculative thread context. Instruction buffer B 420 is stalled at this point and holds the re-fetched instructions while register file B 425 stores the architected state at the time that the exceptional instruction was detected. Thus, instruction buffer B 420 and register file B 425 are part of the architectural thread context at this time. Once the speculative execution of instructions is stopped, instructions in the instruction buffer B 420 are released to the pipeline 430 and thus, instruction buffer B 420 is part of the architectural thread context. If an exceptional instruction is encountered again, the instruction buffer A 410 will be used to re-fetch and hold instructions in an architectural thread context while instructions from instruction buffer B 420 are executed in a speculative manner. This switching between architectural thread context and speculative thread context may be performed many times as necessary during the processing of threads using the mechanisms of the illustrative embodiment.

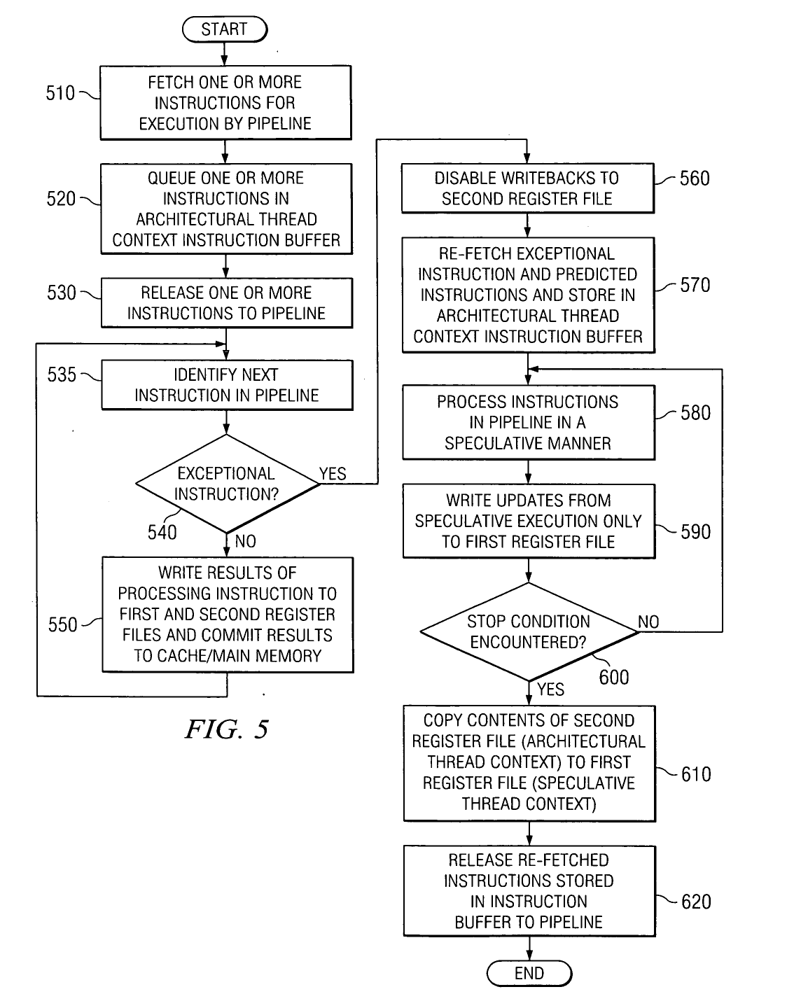

FIG. 5 is a flowchart outlining an exemplary operation of one exemplary embodiment illustrative of the present invention when processing a thread having an exceptional instruction. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

With regard to FIG. 5, two thread contexts are referenced, the “architectural” thread context and the “speculative” thread context. It will be appreciated that prior to encountering an exceptional instruction in the pipeline and after stopping speculative execution of instructions in the pipeline, the “architectural” thread context and the “speculative” thread context have the same register file state. In the time frame between detection of the exceptional instruction and stopping of speculative execution of instructions, the architectural thread context and the speculative thread context have different states. The resources, e.g., instruction buffers, register files, etc., which are part of each thread context may be switched with the handling of each exceptional instruction as previously discussed above.

As shown in FIG. 5, the operation starts by the instruction fetch unit fetching one or more instructions for execution by the pipeline (step 510). An instruction buffer associated with an architectural thread context queues the one or more instructions (step 520). The instruction buffer releases one or more instructions in the instruction buffer to the execution pipeline for execution within the architectural thread context (step 530). The pipeline identifies a next instruction in the pipeline (step 535) and determines whether the next instruction is an exceptional instruction, i.e. an instruction whose processing cannot be completed (step 540). As mentioned previously, this identification and determination may be performed, for example, at a flush point in the pipeline.

If the next instruction is not an exceptional instruction, the pipeline writes the results of processing the next instruction to both a first register file and a second register file such that the first register file and second register file maintain the same state of thread execution (step 550). The pipeline may also commit the results to the cache and/or main memory. The operation then returns to step 535 to process the next instruction in the pipeline.

If the next instruction in the pipeline is an exceptional instruction, the controller is notified of the exception and the controller disables writebacks to the second register file (step 560). The second register file is now considered to be present in the architectural thread context since the second register file maintains an architected state, or snapshot, of the register file contents at the time that the exceptional instruction was detected. The controller then initiates the re-fetching of the exceptional instruction and any predicted instructions following the exceptional instruction into the instruction buffer of the architectural thread context (step 570).

The pipeline continues processing of other instructions in the pipeline in a speculative manner within a speculative thread context (step 580). The pipeline makes updates regarding the results of speculative execution of instructions in the pipeline only to the first register file which is now considered to be within the speculative thread context (step 590). As discussed above, valid bits may be set in the registers of the first register file to indicate which registers hold invalid and valid data so that invalid data is not used to generate load or store addresses which would pollute the caches. Furthermore, if instructions are speculatively processed that result in cache misses, instructions/data required by these instructions are reloaded into the cache in a manner generally known in the art. As a result, these instructions/data will be present in the cache when the pipeline is executing instructions in a non-speculative manner and results may be committed to the cache and main memory.

The controller makes a determination as to whether a stopping condition for the speculative execution of instructions in the pipeline has been encountered (step 600). If not, the operation returns to step 580 and continues to speculatively execute instructions in the pipeline. If a stopping condition has been encountered, the controller initiates the copying over of the contents of the second register file in the architectural thread context to the first register file in the speculative thread context (step 610). The controller then initiates the release of the instructions that are stored in the instruction buffer in the architectural thread context to the pipeline for execution (step 620). The operation of the pipeline then continues in a normal fashion until a next exceptional instruction is detected. That is, the operation shown in FIG. 5 may be repeated many times while the processor is running.

Thus, the illustrative embodiment provides a mechanism by which multiple thread contexts are utilized to reduce the latency in processing instructions of a single thread. This latency is reduced by using one thread context to maintain an architected state of the thread's execution while another thread context is used to perform speculative processing of instructions following a detected exceptional instruction. In this way, data values required for instruction execution may be pre-fetched into the cache before re-issuing instructions to the pipeline after the detection of an exceptional instruction.

It is important to note that while the illustrative embodiment has been described in the context of a fully functioning data processing device and system, those of ordinary skill in the art will appreciate that the processes of the illustrative embodiment are capable of being distributed in the form of a computer readable medium of instructions and a variety of forms and that the illustrative embodiment applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the illustrative embodiment has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system having a pipeline and a cache, for processing a thread, comprising:
detecting a cache miss instruction in the pipeline that results in a cache miss when executed;
performing a first thread context switch operation for switching from a first thread context to a second thread context in response to detecting the cache miss instruction; and
continuing execution of the thread in the pipeline in association with the second thread context without modifying an architected state of a register file at the time that the cache miss instruction is detected and without flushing the pipeline after detection of the cache miss instruction, such that instructions associated with the thread that are processed after the detection of the cache miss instruction are used to pre-fetch data into the cache.

2. The method of claim 1, wherein the architected state is stored in a first register file in association with the first thread context.

3. The method of claim 2, further comprising:
updating, in response to continuing execution of the thread, a state of the execution of the thread in a second register file in associated with the second thread context;
stopping the continuing execution of the thread in the pipeline in response to a criteria being met; and
restoring the architected state to the second register file in response to stopping the continuing execution of the thread in the pipeline.

4. The method of claim 3, further comprising:
re-fetching the cache miss instruction;
storing the re-fetched cache miss instruction in an instruction buffer associated with the first thread context; and
releasing the re-fetched cache miss instruction to the pipeline after restoring the architected state to the second register file.

5. The method of claim 1, wherein continuing executing the thread in the pipeline following the detection of the cache miss instruction comprises:
determining if processing of an instruction of the thread results in a cache miss; and
reloading one of an instruction or a data value into the cache in response to determining that the instruction results in a cache miss.

6. The method of claim 1, wherein the criteria comprises completion of loading of data required by the exceptional instruction into the cache.

7. The method of claim 1, further comprising setting a bit identifying the pipeline to be executing in a speculative mode following detection of the cache miss instruction.

8. The method of claim 1, further comprising:
marking an entry in a register file accessed by the cache miss instruction as invalid in response to detection of the cache miss instruction, wherein continuing execution of the thread in the pipeline comprises:
marking entries in a register file accessed by instructions that are dependent upon the cache miss instruction as invalid.

9. The method of claim 1, wherein performing the first thread context switch operation comprises:
storing the architected state in a register file associated with the first thread context in response to detecting the cache miss instruction; and
disabling modifications to the architected state in the first thread context.

10. The method of claim 3, further comprising:
detecting another cache miss instruction in the pipeline following restoring the architected state; and
performing a second thread context switch operation for switching from the second thread context to the first thread context, wherein the second thread context switch operation comprises:
storing a second architected state of the thread in the second register file, wherein the second architected state is a state of execution of the thread at a time of detection of the second cache miss instruction; and
disabling modification of the second architected state in the second register file.

11. A data processing system, comprising:
at least one processor; and
at least one memory coupled to the processor, wherein the at least one processor comprises:
an execution pipeline;
a first general purpose register, coupled to the execution pipeline, that stores a first register file;
a second general purpose register, coupled to the execution pipeline, that stores a second register file;
a cache coupled to the execution pipeline; and
a controller coupled to the execution pipeline, the first general purpose register, and the second general purpose register, wherein the execution pipeline:
detects a cache miss instruction in the pipeline that results in a cache miss when executed;
stores an architected state in response to detecting the cache miss instruction, wherein the architected state is a state of execution of the thread at the time that the cache miss instruction is detected;
disables modifications to the architected state; and
continues execution of the thread in the pipeline without modifying the architected state and without flushing the pipeline after detection of the cache miss instruction, such that instructions associated with the thread that are processed after the detection of the cache miss instruction are used to pre-fetch data into the cache.

12. The data processing system of claim 11, wherein the pipeline stores the architected state in a first register file in association with a first thread context.

13. The data processing system of claim 12, wherein the pipeline further updates, in response to continuing execution of the thread, a state of the execution of the thread in a second register file in associated with a second thread context, and wherein the controller:
stops the continuing execution of the thread in the pipeline in response to a criteria being met; and
restores the architected state to the second register file in response to stopping the continuing execution of the thread in the pipeline.

14. The data processing system of claim 13, wherein the controller controls:
re-fetching the cache miss instruction following detection of the cache miss instruction;
storing the re-fetched cache miss instruction in an instruction buffer associated with the first thread context; and
releasing the re-fetched cache miss instruction to the pipeline after restoring the architected state to the second register file.

15. The data processing system of claim 11, wherein the pipeline continues executing the thread in the pipeline following the detection of the cache miss instruction by:
determining if processing of an instruction of the thread results in a cache miss; and
reloading one of an instruction or a data value into the cache in response to determining that the instruction results in a cache miss.

16. The data processing system of claim 11, wherein the criteria comprises completion of loading of data required by the exceptional instruction into the cache.

17. The data processing system of claim 11, wherein the data processing system is a heterogeneous multiprocessor system-on-a-chip.

18. The data processing system of claim 12, wherein the heterogeneous multiprocessor system-on-a-chip comprises a control processing unit and a plurality of synergistic processing units that operate under the control of the control processing unit, and wherein the at least one processor comprises is at least one of the synergistic processing units or the control processing unit.

19. The data processing system of claim 13, wherein the plurality of synergistic processing units use a different instruction set from an instruction set used by the control processing unit.

20. The data processing system of claim 11, wherein the data processing system is part of one of a game machine, a game console, a hand-held computing device, a personal digital assistant, a communication device, a wireless telephone device, a laptop computing device, a desktop computing device, or a server computing device.
